(19) United States
(12) Patent Application Publication
(10) Pub. No.: US 2012/0037399 A1
(43) Pub. Date: Feb. 16, 2012

(54) ANISOTROPIC CONDUCTIVE FILM AND METHOD OF FABRICATING THE SAME

(75) Inventors: Chien-Chih HSIAO, Dayuan Township (TW); Chin-Hsin CHIANG, Dayuan Township (TW)

(73) Assignee: Core Precision Material Corporation

(21) Appl. No.: 12/856,908

(22) Filed: Aug. 16, 2010

(51) Int. Cl. H01B 5/00; B05D 5/12; B05D 1/06

(52) U.S. Cl. 174/126.1; 427/474; 427/125

(57) ABSTRACT

A method of fabricating anisotropic conductive film comprises the steps of: mixing conductive particles, a resin material and a solvent to form slurry; and providing a separate means for progressively distributing the conductive particles on one side of the resin material when forming the anisotropic conductive film from slurry. The method disclosed in the present invention is easy to use, and the anisotropic conductive film fabricated by the method has high conductive particles capturing rate.

### BACKGROUND OF THE INVENTION

1. Field of the Invention

This invention generally relates to an anisotropic conductive film and method of fabricating the same, and in particular to an anisotropic conductive film having the conductive particles progressively distributing structure.

2. Description of Prior Art

Anisotropic conductive film (ACF) mainly comprises a resin material and conductive particles, and is primarily used to connect different substrates and wires. The two different substrates require an electrical connection, and ACF has properties of vertically (Z-direction) electrical conduction and left and right forming a plane (X and Y direction) electrical insulation, and ACF may require additional properties such as excellent moisture-proof feature, adhesiveness, electrical conductivity and insulation.

ACF has two major functions (namely, one-directional electrical conduction and glued fixation), and is primarily used in a situation that is not suitable for high temperature of tin-lead soldering process, such as LCD Panel and the driver IC signal transmission links. The method of fabricating ACF generally comprises the steps of mixing conductive particles and a resin material to form a slurry, coating the slurry on a release layer by a high-precision coating technology. The release layer is used to protect ACF from the pollution of the outside.

With the development of high precision and density in LCD field, LCD panel using tape carrier package (TCP) or chip on glass (COG) connection mostly requires reducing the connection intervals, especially in COG connection, because the IC chip has bumps as connection electrodes, the connecting area of COG connection is small than that of TCP connection. Therefore, in order to make sure the electrical conduction on tiny connecting electrodes, it is a very important issue to capture a sufficient number of conductive particles at a high connection reliability.

To resolve the problem, there several anisotropic conductive films with different structure have been proposed. Of which, as shown in FIG. 1, an improved structure of anisotropic conductive film 1 contains two layers of a bottom layer 2 comprising insulating resin and conductive particles, which is a conventional structure of ACF, and an upper layer 3 comprising insulating resin without conductive particles. It may reduce the chance of conductive particles transversely contacting each other by using the double layer ACF.

For example, the granted U.S. Pat. No. 6,020,059 provides a multilayer ACF comprising an anisotropic electroconductive adhesive layer and laminated to thereof at least an insulating adhesive layer. The multilayer ACF may be used in COG technologies, because ACF may directly close to ITO conductive pad after pre-bonding, and effectively increase conductive particles capturing rate on the conductive pad after main-bonding. However, upon forming film of the multilayer ACF requires coating several times, it is more difficult to control thickness in high precision in comparison with an ACF with single layer structure. The process of multiple coating increases production cost of products and maintenance or modified expense of manufacturing equipments, and thus increases the difficulty of conductive particles uniformly distributing due to the reduction of adhesive layer thickness of ACF.

As disclosed in Taiwan Pat. No. 1274780, another connection method of ACF comprises adding photocurable agent into the composition of ACF; disposing on the ACF a photomask corresponding to IC chip connecting electrode design pattern; and irradiating light onto the ACF via the photomask to cause an exposed area of the ACF to undergo photopolymerization and to thereby increase the melt viscosity therein. Using the ACF in such a manner can increase conductive particles capturing rate on the conductive pad after main-bonding. Nevertheless, the photocurable ACF has to align precisely in the process of photopolymerization, and the photomask has to correspond to IC chip connecting electrode design pattern for undergoing exposure. That may increase production cost of products.

Therefore, the inventor conducted researches according to the scientific approach in order to improve and resolve the above drawback, and finally proposed the present invention, which is reasonable and effective.

### SUMMARY OF THE INVENTION

The present invention relates to a method of fabricating anisotropic conductive film for improving the drawback of poor workability the conventional double layer ACF. A separating means, such as gravity, electric field, magnetic field is provided, and solid content (viscosity) adjustment of slurry is conducted to achieve the result of progressively distributing the conductive particles on one side of the resin material when forming the anisotropic conductive film from slurry. In such a manner, the ACF that is not conductive transversely can be fabricated in a simple process.

To achieve the above purpose, the present invention provides a method of fabricating anisotropic conductive film that comprises the steps of: mixing conductive particles, a resin material and a solvent to form slurry; and providing a separate means, such as gravity, electric field, magnetic field, and solid content (viscosity) adjustment of slurry for progressively distributing the conductive particles on one side of the resin material when forming the anisotropic conductive film from slurry.

The following effects may be achieved at least by the present invention:

1. The separate means is a physical force that is easy to combine to the original film forming process. A single layer ACF with high conductive particles capturing rate can be fabricated by a simple process.

2. The ACF fabricated by the present invention is a single layer, wherein the conductive particles are progressively distributing on one side of the resin material, and having high conductive particles capturing rate.

The present specification contains a sufficiently clear and complete disclosure of contents of the invention so as to enable person skilled in the art to understand the contents thereof and to practice said invention. Also, the manner for disclosing the contents, the claims and the drawings according to the specification of the invention can enable person skilled in the art easily to understand the purposes and advantages. Therefore, the detailed features and advantages of the invention are described in the following detailed description of the invention.

### BRIEF DESCRIPTION OF THE DRAWINGS

FIG. 1 shows a schematic view of conventional double layer ACF structure.

FIG. 2 shows a structure of ACF fabricated a method according to a preferred embodiment of the present invention.

FIG. 3 shows a flow diagram of manufacturing steps of ACF according to a preferred embodiment of the present invention.

FIG. 4 shows precipitating the conductive particles to the lower part of the slurry by gravity.

FIG. 5 shows the conductive particles moving to the lower part of the slurry by providing an electric field.

FIG. 6 shows the conductive particles moving to the lower part of the slurry by providing a magnetic field.

FIG. 7 shows images of optical microscope after main-bonding on COG using a conventional double layer structure, conventional single layer structure and progressively distributing on a single layer structure of the present embodiment.

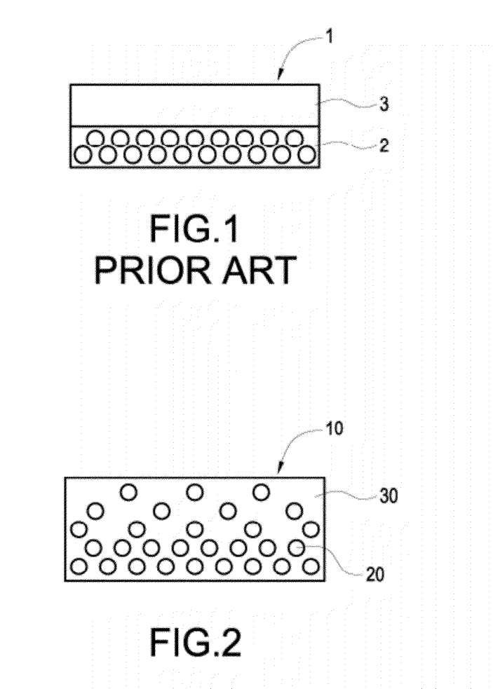

### DETAILED DESCRIPTION OF THE INVENTION

Please refer to FIG. 2, which shows a structure of ACF fabricated by a method according to a preferred embodiment of the present invention. As shown in FIG. 2, the ACF 10 comprises conductive particles 20 and a resin material 30, wherein the conductive particles 20 are progressively distributing on one side of the resin material 30. The conductive particles 20 progressively distributing on one side of the resin material 30 are achieved by providing a separate means, such as gravity, electric field, magnetic field, and solid content (viscosity) adjustment of slurry.

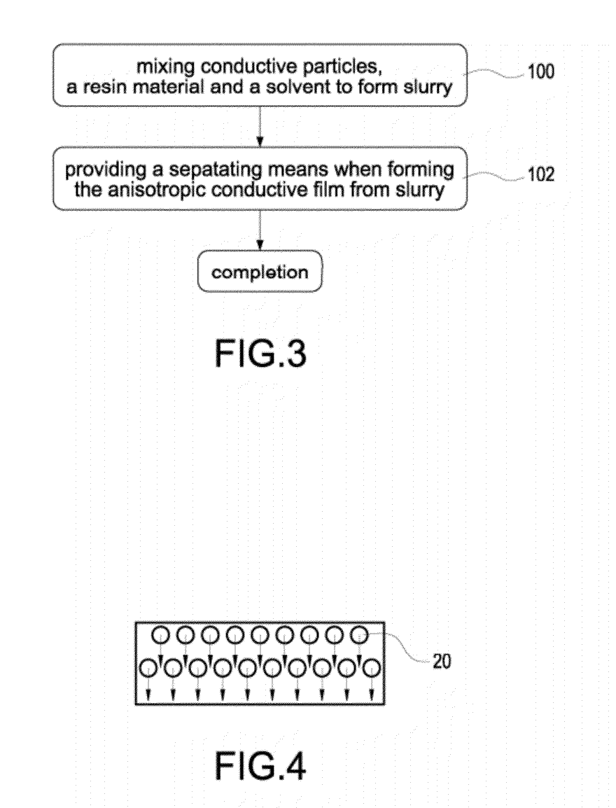

Please refer to FIG. 3, which is a flow diagram of manufacturing steps of ACF according to a preferred embodiment of the present invention. As shown in FIG. 3, the method comprises the steps as following: first step 100, mixing conductive particles, a resin material and a solvent to form slurry, wherein the conductive particles are components selected from the group consisting of Nickel, Gold, Aluminum and Copper, or the conductive particles are resin particles with surface coating a metal selected from the group consisting of Nickel, Gold, Aluminum and Copper; alternatively, the conductive particles comprise the conductive particles with an insulating surface coating; and the resin material is thermosetting polymer material, thermoplastic polymers, such as epoxy resin, polyimide resin, acrylic resin or polyurethane resin and the like or the mixture thereof.

Step 102, providing a separating means, such as gravity, electric field, magnetic field for progressively distributing the conductive particles on one side of the resin material when forming the anisotropic conductive film from slurry. Please also refer to FIG. 4, which shows the separate means precipitating the conductive particles 20 to the lower part of the slurry by gravity. Because the conductive particles 20 have a specific gravity, they gradually precipitate to the lower part of the slurry due to gravity after a period of time. In addition, in order to easily cause the precipitation of conductive particles 20 under the effect of gravity, the solid content of the slurry or the viscosity of the slurry may be reduced to decrease the viscous force of conductive particles in the slurry, reducing the resistance of motion of conductive particles. As shown in FIG. 4, the conductive particles 20 precipitate to the lower part of the slurry to achieve the purpose of progressively distributing the conductive particles on a single layer structure.

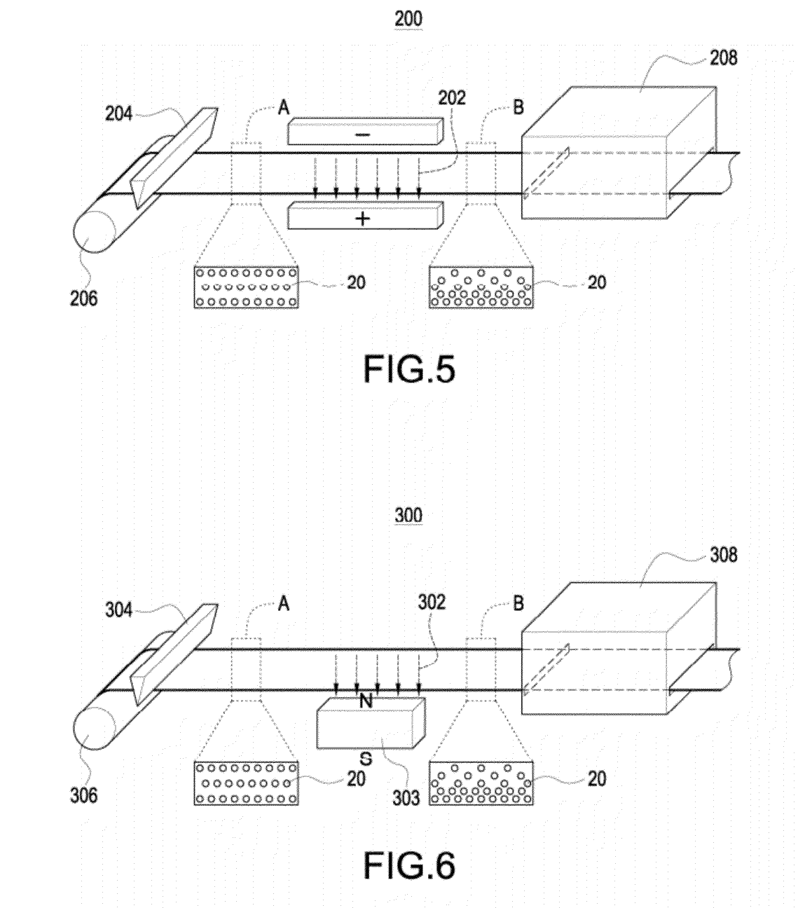

Further, please refer to FIG. 5, which shows the conductive particles moving to the lower part of the slurry by providing an electric field. First, in order to easily cause the precipitation of conductive particles, the solid content of the slurry or the viscosity of the slurry may be reduced to decrease the viscous force of conductive particles in the slurry, reducing the resistance of motion of conductive particles (not shown in the drawings). Next, an electric field 202 is combined to a film forming process 200, which is formed by two metal plates arranged in parallel up and down respectively connecting to positive and negative terminals of a working battery (not shown in the drawings). It should be noted that conductive particles 20 require providing with electric charges before passing through the electric field 202. Next, the slurry is poured in an even manner prior to a scraper 204 of the film forming process 200, and driven forward to pass through the scraper 204 by a roller 206. As shown in FIG. 5, the conductive particles 20 are uniformly distributed in the slurry that are not affected by the electric field 202 when arriving position A, whereas the conductive particles 20 move forward to a direction that is directed by the force of the additional electric field 202 due to the influence of electric field to achieve the purpose of progressively distributing the conductive particles 20 on a single layer structure when the slurry passes through the electric field 202 to arrive position B, finally the ACF is dried by an oven 208.

Moreover, please refer to FIG. 6, which shows the conductive particles moving to the lower part of the slurry by providing a magnetic field. First, in order to easily cause the precipitation of conductive particles, the solid content of the slurry or the viscosity of the slurry may be reduced to decrease the viscous force of conductive particles in the slurry, reducing the resistance of motion of conductive particles (not shown in the drawings). Next, a magnetic field 302 is applied to a film forming process 300, which is provided by a magnet 303. Next, the slurry is poured in an even manner prior to a scraper 304 of the film forming process 300, and driven forward to pass through the scraper 304 by a roller 306. As shown in FIG. 6, the conductive particles 20 are uniformly distributed in the slurry that are not affected by the magnetic field 302 when arriving position A, whereas the conductive particles 20 that contain components of magnetic materials of Iron, Cobalt or Nickel, such as Nickel particles, Nickel-Gold alloy particles, or resin spheres with surface coating Nickel-Gold alloy, or the conductive particles with an insulating surface coating move forward to a direction that is directed by the force of the additional magnetic field 302 due to the influence of magnetic field to achieve the purpose of progressively distributing the conductive particles 20 on a single layer structure when the slurry passes through the magnetic field 302 to arrive position B, finally the ACF is dried by an oven 308.

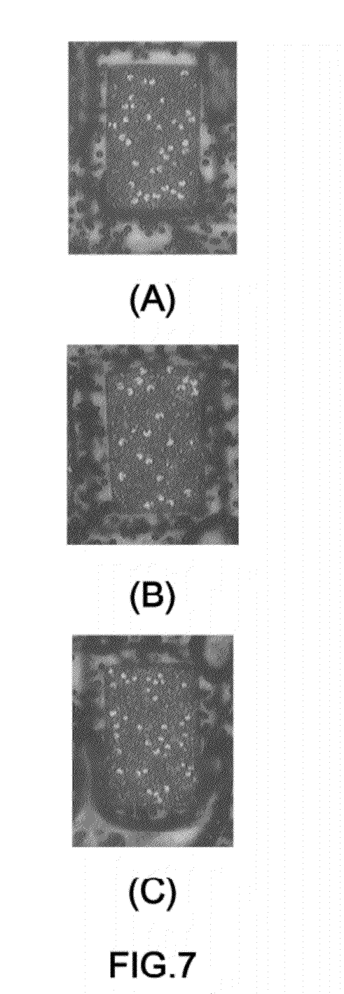

Please refer to FIG. 7, which shows images of optical microscope (OM) after main-bonding on COG using a conventional double layer structure, conventional single layer structure and progressively distributing on a single layer structure of the present embodiment. As shown in FIG. 7, image (A), image (B) and image (C) respectively indicate the conductive particles capturing rate of a conventional double layer structure, conventional single layer structure and progressively distributing on a single layer structure. Compared to the conventional double layer structure and conventional single layer structure, the ACF with progressively distributing conductive particles on a single layer structure of the present embodiment indeed can be fabricated by a simple process and has a high conductive particles capturing rate.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A method of fabricating anisotropic conductive film comprising the steps of: mixing conductive particles, a resin material and a solvent to form slurry; and providing a separating means for progressively distributing the conductive particles on one side of the resin material when forming the anisotropic conductive film from the slurry.

2. The method according to claim 1, wherein the conductive particles are components selected from the group consisting of Nickel, Gold, Aluminum and Copper, or the conductive particles are resin particles with surface coating selected from the group consisting of Nickel, Gold, Aluminum and Copper.

3. The method according to claim 2, wherein the conductive particles comprise the conductive particles with an insulating surface coating.

4. The method according to claim 1, wherein the separate means precipitates the conductive particles to the lower part of the slurry by gravity.

5. The method according to claim 4, wherein the separate means comprises reducing the solid content of the slurry or the viscosity of the slurry.

6. The method according to claim 1, wherein the separate means is providing an electric field.

7. The method according to claim 6, wherein the conductive particles are components selected from the group consisting of Nickel, Gold, Aluminum and Copper, or the conductive particles are resin particles with surface coating selected from the group consisting of Nickel, Gold, Aluminum and Copper.

8. The method according to claim 7, wherein the conductive particles comprise the conductive particles with an insulating surface coating.

9. The method according to claim 6, wherein the separate means comprises reducing the solid content of the slurry or the viscosity of the slurry.

10. The method according to claim 6, wherein the electric field is formed by two metal plates arranged in parallel up and down respectively connecting to positive and negative terminals of a working battery.

11. The method according to claim 6, wherein the conductive particles are provided with electric charges before passing through the electric field.

12. The method according to claim 1, wherein the separate means is providing a magnetic field.

13. The method according to claim 12, wherein the magnetic field is provided by a magnet.

14. The method according to claim 12, wherein the conductive particles are components selected from the group consisting of Iron, Cobalt, Nickel and alloy thereof, or the conductive particles are resin particles with surface coating selected from the group consisting of Iron, Cobalt, Nickel and alloy thereof.

15. The method according to claim 14, wherein the conductive particles comprise the conductive particles with an insulating surface coating.

16. The method according to claim 12, wherein the separate means comprises reducing the solid content of the slurry or the viscosity of the slurry.

17. The method according to claim 1, wherein the resin material is thermosetting polymer material, thermoplastic polymers or the mixture thereof.

18. The method according to claim 1, wherein the resin material is epoxy resin, polyimide resin, acrylic resin or polyurethane resin.

19. An anisotropic conductive film comprising conductive particles and a resin material, wherein the conductive particles are progressively distributing on one side of the resin material.
